(19) United States
(12) Patent Application Publication
(10) Pub. No.: US 2009/0010833 A1
(43) Pub. Date: Jan. 8, 2009

(54) PROCESS FOR PRODUCING ULTRA-FINE POWDER OF CRYSTALLINE SILICON

(75) Inventors: Valery Rosenband, Haifa (IL); Arkady Garbar, Yoqneam Illit (IL); Chariana Sokolinsky, Haifa (IL); Dmitry Lekhtman, Nazaret-Illit (IL); Fernando de la Vega, Zichron Yacov (IL); Thomas Zak, Wyoming, MN (US)

Correspondence Address: FISH & RICHARDSON P.C., PO BOX 1022, MINNEAPOLIS, MN, 55440-1022, US

(73) Assignee: Cima Nano Tech Israel Ltd.

(21) Appl. No.: 11/946,462

(22) Filed: Nov. 28, 2007

Related U.S. Application Data
(60) Provisional application No. 60/867,520, filed on Nov. 28, 2006.

(51) Int. Cl. C01B 33/021; H01B 1/04; B32B 5/16; B05D 1/00

(52) U.S. Cl. 423/349; 252/500; 428/402; 427/331

(57) ABSTRACT

A method of producing a fine powder of crystalline silicon.

### RELATED APPLICATIONS

This application claims the benefit under 35 U.S.C. §119(e)(1), of prior U.S. provisional application 60/867,520, filed Nov. 28, 2006.

### TECHNICAL FIELD

This invention relates to the field of silicon semiconductors and, more specifically, to a process for making ultra-fine crystalline silicon powder, and to ultra-fine crystalline silicon powder produced by the process and to liquid compositions containing such powder.

### BACKGROUND

Semiconductor materials are needed in many electronic devices. They are present in many active devices such as diodes, transistors, light-emitting diodes (LEDs), sensors, thin film transistors (TFTs), integrated circuits, smart cards, smart toys, displays, radio frequency identification (RFID) tags, solar cells, electroluminescent (EL) devices, etc.

Active devices and semiconductor layers are generally made today by complicated, expensive, capital-intensive methods (lithographic, vacuum deposition, and etching techniques). Most of these devices are made of several layers. A more convenient, flexible and cheaper way of making these devices is to transport molecules and materials in solutions (as in biological systems) to create the desired architecture. The transfer of the materials through liquids to the desired place can be achieved by common printing methods (flexographic, gravure, ink-jet and others) enabling printed electronics. Printed electronics offer many advantages including lower capital costs, fewer barriers to low and high volume production (depending on the printing method), and the possibility of local manufacture.

The ability to print semiconductor layers opens a wide range of new applications and designs, as well as enabling the production of a wide range of devices on flexible and inexpensive substrates. Printing methods, along with the availability of suitable printable materials, will eventually enable the printing of semiconductor layers in much the same way as newspapers are printed today by high-speed printing presses.

To enable semiconductor printing, suitable semiconductor inks must be developed. Most of the present work relating to semiconductor inks is based on organic semiconductors because they can be processed in liquid form and therefore formulated into printing inks.

Organic semiconductors have much lower quality than common inorganic semiconductors such as crystalline silicon. One method of comparing semiconductor performance in, for example, a transistor, is to measure what is known as field-effect mobility, also referred to herein as simply “mobility” or “electron mobility”. This is a measure of how fast a charge will move in a material at a certain electric field. Stated in centimeters squared per volt per second (cm²/V-s), field effect mobility a factor in determining, for example, the speed at which a transistor will turn on and off. Crystalline silicon, has a mobility of 1450 cm²/V-s. Amorphous silicon semiconductors can achieve mobilities of only around 0.1 cm²/V-s, and organic semiconductors have electron mobilities of only about 0.2 cm²/V-s, and in very controlled environments can achieve 2.0 cm²/V-s (pentacene). Thus, the mobility of crystalline silicon in these devices is orders of magnitude better than that of organic semiconductors and amorphous silicon, and the ability to formulate semiconductor inks with crystalline silicon would result in transistors and other electronic devices having much better performance and more widespread applicability than semi-conductor inks formulated with organic semiconductors due to improvements in the properties that depend on mobility such as speed and power consumption.

Silicon is a very common element, but is normally bound in silica (SiO₂). Processing silica to produce silicon is a very energy-intensive and expensive process. The current industrial production of silicon is via the reaction between carbon (charcoal) and silica at a temperature around 1700° C., in a process known as carbothermic reduction.

Newer methods have been developed to produce crystalline silicon particles and films at lower costs, but few have been successfully used for large scale production. Prior to the present invention, a need existed for a simple, energy-efficient, scalable process for producing crystalline silicon powder having greater mobility than the mobility obtainable with organic semiconductors and that could be processed into printable inks.

### SUMMARY

Applicants have discovered a method for producing a fine powder of crystalline silicon comprising (a) forming a mixture comprising a silicon precursor powder, such as silicon dioxide, and a second powder that will generate an exothermic reaction when heated; (b) heating the mixture in a reactor to a temperature at which the exothermic reaction occurs; (c) treating the reaction mixture with a leaching agent to leach unwanted materials from the reaction mixture; and (d) isolating the crystalline silicon powder.

A further embodiment of the process relates to the inclusion of additional materials in the reaction mixture, such as inert materials, to control the reaction temperature or heat dissipation as well as preventing particle agglomeration and providing particle protection and stabilization.

Another embodiment of the process relates to the inclusion of doping materials in the reaction mixture.

Another embodiment of the process relates to maintaining the temperature of the reaction in step (b) below the melting temperature of the crystalline silicon powder.

Another embodiment relates to a method for producing a fine powder of crystalline silicon comprising (a) forming a mixture comprising silicon dioxide and magnesium powder; (b) heating the mixture in a reactor under inert gas to a temperature at which an exothermic reaction occurs while maintaining the temperature of the reaction below the melting temperature of the crystalline silicon product; (c) treating the reaction mixture with a leaching agent to leach unwanted materials from the reaction mixture; and (d) isolating the crystalline silicon powder.

Applicants have also discovered fine powder of crystalline silicon having single particle mobility of at least 1 cm²/V-sec., and preferably at least 5 cm²/V-sec. when measured according to the test method described below in Example 9. Preferably, the fine powder has an average particle size (D₅₀) of 100 nanometers or less. The powder can be formulated in a liquid carrier to produce inks and coating compositions that can be used in a variety of printing and coating applications. The powder may also be treated with doping material after it is formed, either before or after deposition on a substrate, to enhance its electrical properties.

The above summary is not intended to describe each disclosed embodiment or every implementation of the present invention. The Figures and the detailed description that follow more particularly exemplify illustrative embodiments.

### BRIEF DESCRIPTION OF THE DRAWINGS

FIG. 1 is an illustrative schematic reaction of one embodiment of the process of the invention.

FIG. 2 is an illustrative schematic reaction of another embodiment of the process of the invention.

FIG. 3 is an illustrative schematic reaction of another embodiment of the process of the invention.

FIG. 4 is an SEM of the crystalline silicon powder produced as described in Example 2.

FIG. 5 shows the results of x-ray diffraction analysis of the crystalline silicon powder produced as described in Example 2.

FIG. 6 is an SEM of the crystalline silicon powder produced as described in Example 4.

FIG. 7 shows the results of x-ray diffraction analysis of the crystalline silicon powder produced as described in Example 4.

FIG. 8 shows the differential thermal analysis curves for two different reaction schemes.

FIG. 9 is a graph showing particle size as a function of reaction temperature.

FIG. 10 is an SEM of the crystalline silicon powder produced as described in Example 6.

FIG. 11 shows the results of x-ray diffraction analysis of the crystalline silicon powder produced as described in Example 6

FIGS. 12a, 12b, and 12c are schematic drawings illustrating the sample preparation for the single particle mobility test described in Example 9.

FIG. 13 is a graph plotting the measurements made to determine the extrapolated voltage used to determine the trap density component of the single particle mobility test described in Example 9.

FIG. 14 is a graph showing a repeat of the measurements shown in FIG. 13.

FIG. 15 shows the results of the oxidation test performed on the boron-doped silicon powder described in Example 8.

FIGS. 16a 16b are SEMs of the boron-doped silicon powder described as Si-045 in Example 8.

FIG. 17 shows the results of x-ray diffraction analysis of the boron-doped silicon powder described as Si-045 in Example 8.

FIGS. 18a and 18b are SEMs of the boron-doped silicon powder described as Si-046 in Example 8.

FIG. 19 shows the results of x-ray diffraction analysis of the boron-doped silicon powder described as Si-046 in Example 8.

### DETAILED DESCRIPTION

Applicants have discovered a process for producing a fine powder of crystalline silicon As used herein, “fine” powder refers to powder having an average particle size less than one micron. The process is also capable of producing crystalline silicon powder in the “nano” size range, which refers to powder having an average particle size of 100 nanometers or less.

Applicants have discovered that such powders can be produced by a process that utilizes self-propagating high-temperature synthesis (SHS). SHS is a combustion-driven material synthesis technique that has been used to form various metallic, ceramic and composite materials. The process is carried out in a reaction vessel (e.g., a closed reaction vessel) and generally under an inert gas to prevent oxidation of the final product during or after synthesis. The reaction process is initiated by either locally igniting a powder mixture using a heated wire, electric spark, laser beam, etc., or by heating the entire mixture to some elevated temperature at which a “thermal explosion” occurs. Either method produces a chemical reaction that is sufficiently exothermic to sustain a combustion wave that coverts the reactant powder into the desired product. The thermal explosion method is the preferred method of carrying out the process.

According to the process, the first step involves forming a powder mixture. One ingredient of the mixture is a powder of a silicon precursor. The silicon precursor is preferably silicon dioxide SiO₂, such as fumed silica. Other silicon precursors may be used such as silicon carbide or silicon nitride. In general, the smaller the particle size of the silicon precursor, the better.

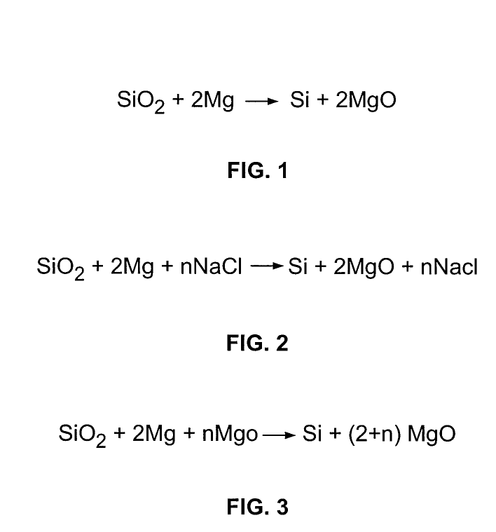

The other ingredient in the initial powder mixture is a material that will generate a exothermic reaction with the silicon precursor when heated. Generally, for the SHS process to proceed by local ignition where the reaction must pass from one point to another through the reaction mixture, the reactants must be selected such that the calculated adiabatic temperature of the reaction is above 1500° C. When the entire volume of the reaction mixture is heated at the same time, heating to a temperature of 1500° C. is not required. The preferred second ingredient is magnesium powder and the schematic reaction is shown in FIG. 1. The calculated adiabatic temperature of this reaction is 1847° C. The initial size of the magnesium powder does not influence the reaction because it reacts in a molten state. Magnesium may be substituted by other materials such as calcium and aluminum. When using aluminum, some formation of alumina Al₂O₃ may result.

The silicon precursor powder and the other ingredient powder are mixed thoroughly to form a uniform mixture. Ball milling for several hours works well to produce a uniform mixture, although other conventional methods of mixing powders also can be used. Preferably, the mixing is carried out prior to heating the ingredients.

The mixture is heated to a temperature at which an exothermic reaction occurs. The heating process may be performed in many different configurations provided that enough energy is incorporated and the energy density is achieved in the reaction mixture to enable the SHS process to proceed. The parameters to be considered for this purpose include, but are not limited to, temperature profile, geometry of the oven or crucible, heating elements inside and outside the oven, material mass and volume, mixing method and mode, temperature range in the initiation step, and energy source (heater, electric furnace, induction, hot filaments, dissipated energy, etc).

In general, when the entire volume of the reaction mixture is heated, the process requires that the temperature of one solid component reach its melting point. In the case of the reaction illustrated in FIG. 1, the melting point of magnesium in the Mg/SiO₂ system is 650° C., and heating the mixture to a temperature above this temperature should insure that the reaction proceeds. The exothermic reaction can also begin at lower temperatures, e.g., on the order of about 535° C.

The reaction products, properties and purity are generally optimized when the combination of initial temperature and composition of materials is such that the peak temperature achieved by the reacting materials is less than the melting point of the desired product but sufficiently high to result in a self-propagating reaction front. This is particularly true if nano-size powder is desired. Temperature conditions can be modified by the geometry of the crucible (reactor) where there is significant heat dissipation from the reaction mixture to the crucible during the reaction. Additional cooling elements or heat dissipation devices can be added to the crucible (reactor). The material can also be mixed during the reaction by mixing techniques such as providing external agitation, stirring, stirring with mixer, introducing a stream of gas through the material, fluidized bed, rolling the crucible (reactor), tumbling, rotary kiln (cement), roll mill, batch and continuous process screw, insulating walls, fractionation of the product, extrusion and others.

Another method of controlling the reaction temperature is to add inert materials to the reaction mixture. The range of inert materials that can be used is wide, and includes materials such as elemental metals, oxides of metals, inorganic salts of the metals (chlorides, sulfides, nitrates, etc.) and others. The selection must be made such that the material does not react with the other reactants, and the inert material can be easily washed or leached from the reaction mixture after the reaction is complete. In the Mg/SiO₂ reaction system, temperature can also be controlled by adding excess magnesium.

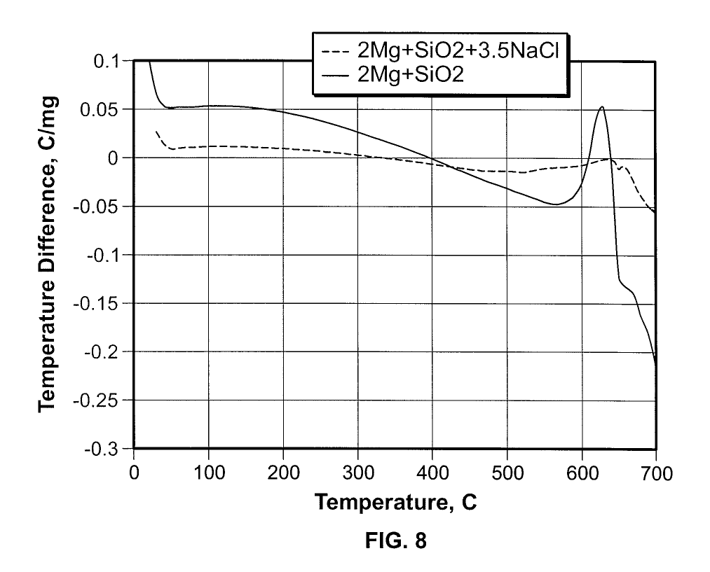

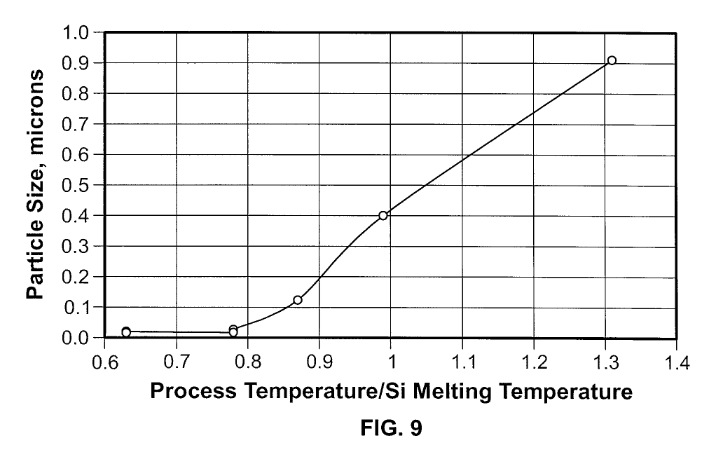

In the Mg/SiO₂ reaction system, it has been found that the addition of NaCl is particularly effective to lower the temperature reached during the reaction process. The schematic of this reaction is shown in FIG. 2. The higher the amount of NaCl added, the lower the temperature reached in the process. For example, in FIG. 8 the differential thermal analysis (DTA) curve for the system 2Mg+SiO₂ and 2Mg+SiO₂+3.5 NaCl indicates a significantly lower reaction temperature than that of the 2Mg+SiO₂ reaction. FIG. 9 illustrates the size (calculated on the specific surface area of the produced silicon powder) dependence on reaction temperature.

Another preferred inert material for controlling the temperature of the reaction is magnesium oxide MgO. MgO is also a product of the reaction as shown in the reaction schemes of FIGS. 1 and 2, so it avoids the introduction of contaminants such sodium and chloride ions. The reaction scheme for this reaction where MgO is included in the initial reaction mixture is shown in FIG. 3. Using MgO also helps to prevent the formation of magnesium silicide and increases the yield of the silicon powder.

After the reaction is complete, and preferably after the temperature has been reduced, the unwanted products of the reaction and any inert materials and other impurities are removed from the reaction mixture. Removal can be accomplished by chemical or physical means, or a combination thereof. Gas phase, liquid phase, or solid phase processes or combinations thereof may be employed to remove the unwanted products and impurities. For example, the removal of these materials can be achieved by processes such as, but not limited to, sublimation, reaction to form a gas, solubilization, dissolving, chemical or plasma etching, sandblasting, diffusion, magnetic or electric migration, or any other means of removal.

Preferably, the unwanted products of the reaction and any inert materials and other impurities are removed by a washing or leaching process using a leaching agent. Liquid leaching agents are preferred as the leaching media. The unwanted materials are leached by immersion or contact with the leaching media at a predetermined temperature for a predetermined amount of time. The leaching process can be batch or continuous, and can be performed in closed or open reactors or vessels. The leaching media may be at room temperature or it may be cooled or heated, depending on the desired kinetics of the leaching process. The leaching medium can be refreshed or replenished during the process. Additional leaching steps may be necessary to remove all unwanted materials and to achieve higher purity. For example, inert NaCl can be washed with water. Excess MgO can be leached by acids (HCl, acetic acid or any suitable acid, e.g., MgO+2HCl=MgCl₂+H₂O). Excess magnesium can be leached by acids (HCl, acetic acid or any suitable acid, e.g., Mg+2HCl=MgCl₂+H₂). Excess silica can be leached by HF (SiO₂+4HF═SiF₄+2H₂O). HF will also leach amorphous silicon, if formed, as it reacts readily with amorphous silicon and very slowly with crystalline silicon.

The properties of the silicon powder, especially electrical properties, are very sensitive to the presence of impurities. Impurities can have good or adverse influence on the material properties. Some are known to decrease the electric properties of the silicon, for example, ions such as sodium and others. Other materials will enhance the electrical properties. For example, the conductivity of silicon can be enhanced by very low concentrations of doping materials such as boron, phosphorus and others. Very low concentrations, even in the ppm level, can have this effect. In order to use the silicon powder in semiconductor applications, special care is generally taken to avoid the presence of uncontrolled and/or undesired impurities. Many methods known and applied in the semi-conductor industry and wafer production may be applied to the silicon powder or in the process of making it to reduce the presence of impurities.

Several approaches can be implemented to maximize the purity of the crystalline silicon powder. Purification steps can be applied to the final deposited material or to any step between the production of the raw materials up to the deposition step, as described below.

Use of very pure starting materials will decrease the amount of uncontrolled impurities in the material made. The materials used in the production process, may be purified in an earlier stage. Fumed silica can be made from ultra pure SiCl₄ or from any other suitable ultra pure reactants. Magnesium may be made by electrolysis of very pure magnesium carbonate or by any other suitable production method with pure reactants. It is desirable that the surface of the magnesium or metal powder used in the process be clean of organics. The same is true for all other materials such as the inert material, HF, HCl, deionized water and all other reactants and materials involved in the production process.

Furthermore, to obtain very pure materials it is possible to use pure magnesium oxide crucibles, or crucibles made of inert materials that won't introduce impurities into the fine powder produced.

The particles or the deposited patterns can be exposed to different cleaning methods, including, but not limited to, RCA methods (a semi-conductor standard cleaning method). Such methods include washing or exposure to cleaning liquids or solutions, or also gas materials with cleaning properties. Examples of liquids and solutions may be those applied in the standard wet cleaning processes used in the semiconductor wafer industry. Examples of these solutions and liquids include piranha, hydrogen peroxide, standard clean (SC-1 & SC-2), hydrofluoric acid, buffered hydrofluoric acid, ammonium hydroxide, etc., and combinations and modifications of these materials. Gases such as hydrogen fluoride or other cleaning gases may be used to clean the materials.

Additional methods may be dry cleaning, plasma based methods, use of chelating agents in the solutions, ozone, cryogenic aerosol cleaning, and others.

To clean the surface of the particles any dissolving method capable of cleaning the surface may be used. Usually impurities in the production process are unreacted materials and the inert material. Also, some undesirable reaction products as well as other undesirable materials may be present. The above methods can be used and also any dissolving method capable of cleaning these materials.

The oxide layer on the silicon particles may be considered an undesired impurity and cleaned or reduced by one or a combination of cleaning processes. Also, the oxidation step can be used to purify the particles by inducing diffusion of impurities, capturing impurities which will be cleaned when the layer is cleaned, oxidizing the impurities together with the silicon and increasing the solubility and/or reactivity of the impurities in the different cleaning solutions.

The cleaning process may also be performed with the assistance of additional methods to control it, to enhance the efficiency or for any other reason. These methods may include ultrasonic baths, ultrasonic probes, megasonic energy-generating devices, and stirring devices.

Cleaning methods may be applied alone or in combination with other cleaning methods. Preferably, the purification steps are repeated to achieve the highest purity.

Cleaning conditions used may be any temperature, pressure, liquid and solution concentrations, etc. that won't damage the particles and their properties and preferably, in a safe mode and environment. These will include hoods, wet sinks housed in hoods, in manual or automatic set ups (robots). The cleaning process may be performed by immersing the materials in the liquids or solutions, by spraying them, with and without scrubbing, brushing, etc.

After the cleaning process several routes are possible, including water cleaning, heat drying, room temperature drying, air drying, IR drying, vacuum drying, spin drying, isopropyl alcohol vapor drying, etc.

A preferred approach to obtaining very pure material is to reduce the oxide layer on the surface. This can be achieved by a number of methods including, selective reduction, HF cleaning, and performing the reaction and storing the material in inert atmospheres.

The processes described above may or may not be followed by additional steps such as particle protection (e.g. hydrogen termination, sililation, storing the material in protective liquid or inert atmosphere and any other suitable method).

Crystalline silicon powder produced by the process of the invention is of high purity and has been shown to have very high single particle mobility when tested as described below in Example 9. The undoped powder is characterized by mobility greater than 5 cm²/V-sec, and preferably greater than 50 cm² V-sec or greater than 500 cm²/V-sec.

Dopant materials such as, for example, boron, aluminum, gallium, indium, phosphorous, arsenic, antimony, and the like may be added to the powder. Doping can be performed at any step of the process. It can be performed in the reaction step by introducing dopants through the raw materials and or through the inert material or reactor material. The dopants may be introduced in the process of manufacturing the raw materials, as oxides, precursors, as solutions or solids, with SiCl₄, etc. The doping process may also be performed by exposing the reaction mixture in the oven (crucible), or after production by exposing the particles or the deposited pattern to doping material gas, solutions, precursors, with SiCl₄, etc.

In order to prepare compositions of the crystalline silicon powder that can be printed or coated onto substrates, the powder may be dispersed in a suitable liquid carrier.

The invention is further illustrated by the following non-limiting examples. Ingredients used in the examples are identified in the following table.

| | | Chemical | | | |
|---|---|---|---|---|---|
| | | name | Chemical | | |
| Name | Description | (formula) | Grade | Supplier | Remarks |
| Silica (fumed) | Powder with 0.014μ | SiO₂ | According to | Chen Samuel | Sigma |
| | particles, BET-194 m²/g | | specification | Chemicals | |
| Magnesium | Light grey coarse | Mg | 99% min | Chen Samuel | Fluka |
| | powder 30-80 mesh | | | Chemicals | |
| Sodium | | NaCl | Analytical 99% | Chen Samuel | Cat. #5553470 |
| Chloride | | | min | Chemicals | |
| Hydrochloric | Concentration 37% | HCl | Analytical | Chen Samuel | Cat. #8410501H |
| acid | | | | Chemicals | |
| Hydrofluoric | Concentration 48% | HF | Analytical | Chen Samuel | Riedel de Haën |
| acid | | | | Chemicals | |
| Water RO | | | | CNTI | |
| Acetone | Clear colorless liquid | C₃H₆O | 99.9% | Chen Samuel | Green labeled |
| | | Dimethyl | | Chemicals | See Technical |
| | | ketone | | | specifications |
| Argon | Gas | | 99.999% | | |
| Magnesium | | MgO | Puriss, light 99% | Chen Samuel | Riedel de Haën |
| Oxide | | | | Chemicals | Cat. # 13138 |

### EXAMPLE 1

Fumed silica (13.8 g) was mixed for three hours in a ball mill with 10 g of magnesium sawdust (molar ratio SiO₂:Mg=1:1.8). The mixture was heated in a graphite crucible in an argon flow of 2 l/min in a closed reactor to 700° C. The reactor was allowed to cool to 35° C. in a constant argon flow of 1 l/min. A loose black-blue powder was formed. This powder was leached in 375 ml of 20% acetic acid at a temperature of 50° C. for two hours. After filtration, the powder was treated with 5% HF for one-half hour to dissolve the remaining SiO₂ and SiO₂ formed during leaching from the reaction of SiH₄ with air. Then, the powder was washed in acetone and dried in a vacuum oven at 70° C. for two hours. A black-brown silicon powder was obtained. The powder had an average particle size D₅₀ of 13.36 μm and D₉₀ of 48.1 μm, and a surface area of 12.3 m²/g (BET method).

### EXAMPLE 2

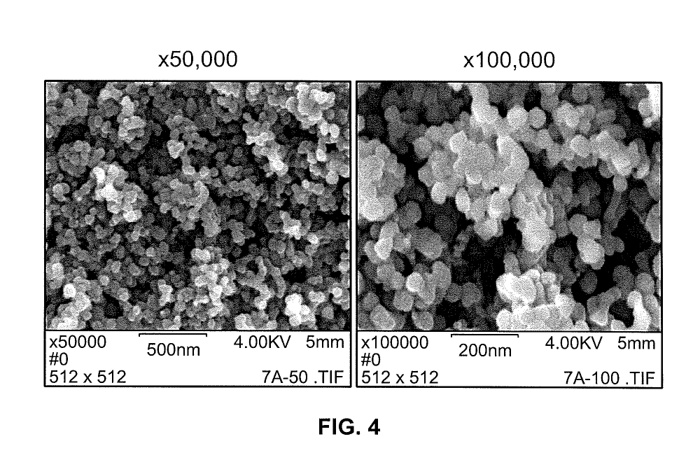

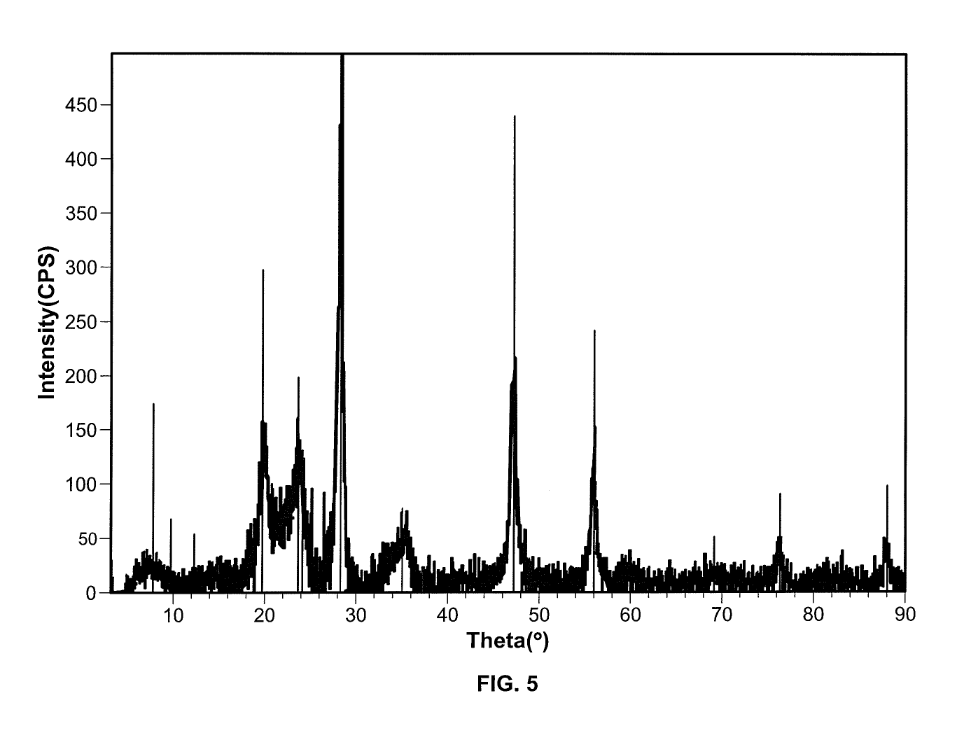

Fumed silica (80 g) was mixed for five hours in a ball mill (with 400 g ZrO₂ and Al₂O₃ balls) with 64 g of magnesium sawdust (Molar ratio SiO₂:Mg=1.2). Then 272 g of NaCl were added and mixed for an additional six hours. The mixture was heated in a graphite crucible in an argon flow of 5/min in a closed reactor to 700° C. The reactor was allowed to cool to 35° C. in a constant argon flow of 11/min. A dark-brown loose powder (411 g) was obtained. The powder was washed with three liters of deionized water, filtered and dried, and 190 g of powder were obtained. A portion of this powder (95 g) was added to 1380 g of HCl (14%) and left for 24 hours at room temperature. Then the powder was filtered and dried, and 36 g of powder were obtained. A portion (10 g) of this powder was added to 550 ml HF (5%) at room temperature for 30 minutes after which the powder was filtered, washed with acetone and dried (in vacuum oven at 70° C.). A black-brown powder (2 g) was obtained. The powder had a surface area of 61.7 m²/g (BET method), and an average particle size (D₅₀) below 100 μm. An SEM of the particles is shown in FIG. 4. The particles had good crystallinity as shown by x-ray diffraction analysis. See FIG. 5.

### EXAMPLE 3

A similar procedure as that described in Example 2 was used, except for different fumed silica and magnesium ratios (mainly SiO₂:Mg=1:1.8 and SiO₂:Mg=1:2.3), below and above the stoichiometric ratio for this system, respectively. In accordance with thermodynamic calculations, the products of the reaction contain, in the first case, Si, MgO and magnesium silicate Mg₂SiO₄, while in the second case Si, MgO and Mg. Total quantity of starting materials in each experiment was 16.5 g. Three experiments with the same silica-magnesium ratio (1:1.8) were done to check the reproducibility. The stages of synthesis and leaching are presented below in Table 1. The powder obtained was washed with 400 ml acetic acid (20%) at 60° C. for 4 hours, then by 125 ml HCl (20%) at 60° C. for 1 hour. This was followed by 100 ml HF (20%) at room temperature for 1 hour. The powder obtained was washed with acetone and dried (as described in Example 2). The results of representative mass balance experiments during the various stages of the process are reported in Table 1 below. The particle size and surface area of the particles are shown in Table 2.

TABLE 1

| | Mass of Samples, g | | | | |
|---|---|---|---|---|---|
| Stages | Exp. A | Exp. B | Exp. C | Exp. D | Exp. E |
| Initial | 16.46 | 16.50 | 16.54 | 16.50 | 16.58 |
| After Reaction | 15.58 | 15.65 | 15.69 | 15.38 | 16.03 |
| | (94.7%) | (94.8%) | (94.9%) | (93.2%) | (96.7%) |
| After Acetic acid | 7.01 | 7.33 | 6.62 | 5.52 | 6.25 |
| After HCl | 5.86 | 6.22 | 5.25 | 4.08 | 4.85 |
| After HF | 2.85 | 3.11 | 3.34 | 3.35 | 3.32 |
| Yield, % | 64 | 70 | 78 | 83 | 82 |

TABLE 2

| | | | Calculated | |
|---|---|---|---|---|
| | SiO₂/Mg | Surface Area | Average Size | |
| Sample | Molar Ratio | m²/g | (microns) | Yield % |
| Silicon A | 1:1.8 | 4.50 | 0.57 | 64 |
| Silicon B | 1:1.8 | 6.52 | 0.39 | 70 |
| Silicon C | 1:1.8 | 2.82 | 0.91 | 78 |
| Silicon D | 1:2.3 | 5.37 | 0.48 | 83 |

### EXAMPLE 4

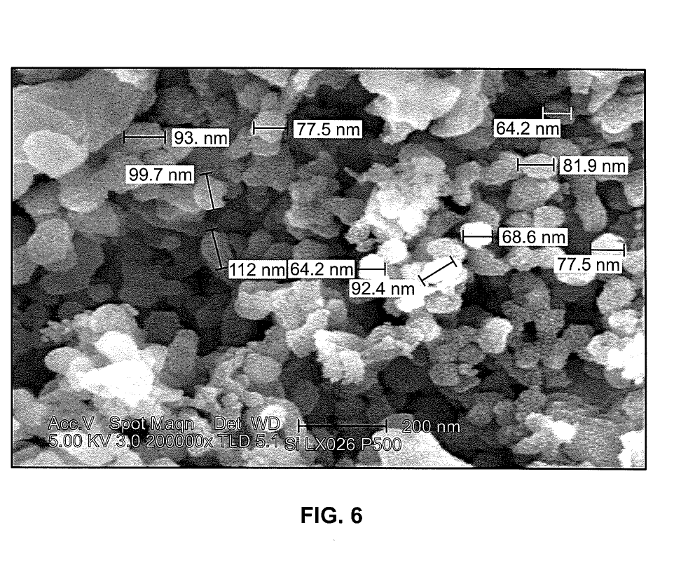

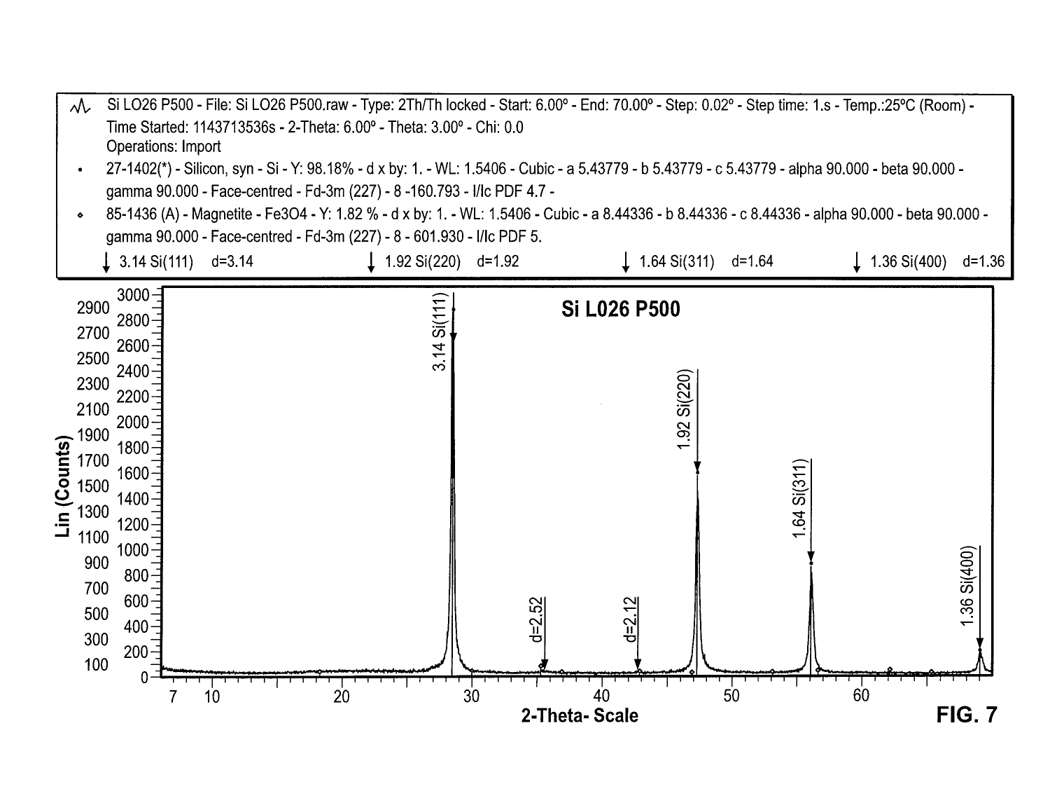

Fumed silica (400 g) was mixed for five hours in a ball mill (with 400 g ZrO₂ and Al₂O₃ balls) with 320 g of magnesium powder (Molar ratio SiO₂:Mg=1.2). Then, 1362 g of NaCl was added and mixed for an additional six hours. The mixture was heated in a graphite crucible in an argon flow of 5 l/min in a closed reactor to 700° C. The reactor was then allowed to cool to 35° C. in a constant argon flow of 11/min. A dark-brown loose powder (2060 g) was obtained. The powder was washed with 15 liters of deionized water, filtered and dried. The powder obtained (950 g) was added to 13800 g of HCl (14%) and left for 24 hours at room temperature, after which the powder was filtered and dried. The powder obtained (950 g) was added to 10750 ml HF (5%) at room temperature for 30 minutes after which the powder was filtered, washed with acetone and dried (in a vacuum oven at 70° C.). A black-brown powder (19 g) was obtained. An SEM of the powder is shown in FIG. 6. The powder had a surface area of 61.7 m²/g (BET method), average particle size below 100 nm, and good crystallinity as verified by x-ray diffraction analysis shown in FIG. 7.

### EXAMPLE 5

Fumed silica (9.7 g) was mixed for 5 hours in a ball mill (with 400 g ZrO₂ and Al₂O₃ balls) with 7.9 g of magnesium powder and 46.1 g of magnesium oxide. The molar ratio SiO₂:Mg was 1:2. The mixture was heated in a graphite crucible in an argon flow of 5 I/min in a closed reactor to 700° C. The reactor was allowed to cool to 35° C. in a constant argon flow of 1/min. A light-brown loose powder (48 g) was obtained. The powder was added to 2700 g of HCl (5%) and left for 24 hours at room temperature, after which the powder was filtered and dried. This powder was added to 470 ml HF (7%) at room temperature for 30 minutes after which the powder was filtered, washed with acetone and dried (in a vacuum oven at 70° C.). A black-brown powder (2.5 g) was obtained. The powder had an average particle size below 100 nm, surface area of 62.8 m²/g (BET), and crystalline silicon content of over 89% (ICP).

### EXAMPLE 6

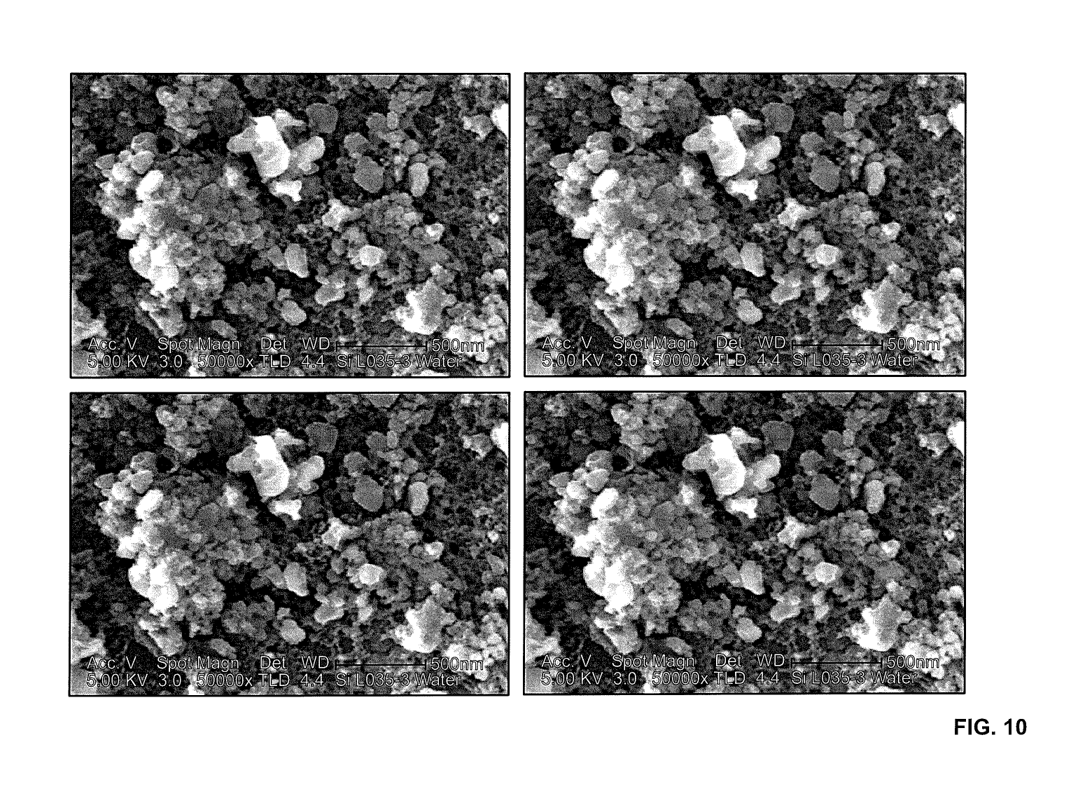

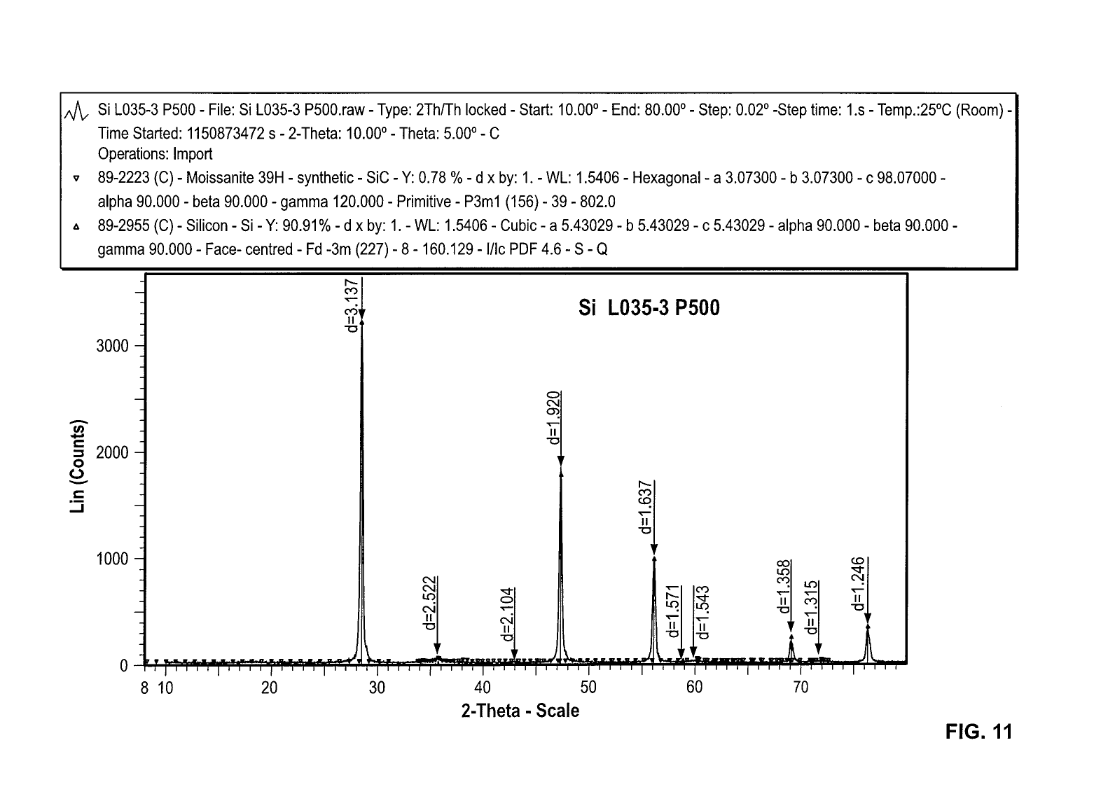

Fumed silica (80 g) (initial content of silicon 37.3 g) with particle size of 14 nm was mixed for 6 hours with 64 g of magnesium powder (200-600 microns in size) and 374 g of magnesia (MgO). Synthesis was carried out in a closed reactor in an argon flow of 5 l/min. The reactor was allowed to cool, and the first leaching was carried out in 9 l of 16% HCl during a period of 16 hours. After filtration, the powder obtained was washed in water and dried in a vacuum furnace at 60° C. The powder obtained (70 g) was a mixture of Si and SiO₂. A second leaching was conducted during a one hour period in 500 ml of 5% hydrofluoric acid HF. After filtration, washing in water and drying at room temperature, 19 g of nano-size silicon powder were obtained. Yield was about 51%. Properties of the powder are summarized in the following table. An SEM of the powder is shown in FIG. 10, and the x-ray diffraction analysis is shown in FIG. 11.

| Item | Property | Value | Units | Test Method |
|---|---|---|---|---|
| 1 | PSD (Coulter), Water, 15 | | μm | PSD Test Method |
| | min sonic: | | | Described Below |
| | D₅₀ | 0.089 | | |
| | D₁₀ | 0.056 | | |
| 2 | Average prime particle | 0.08 | μm | HR SEM |
| | size | | | |
| 3 | SSA (BET): | 72.05 | m²/g | SSA Test Method |
| | | | | Described Below |
| 4 | LODB (BET): | 3.2 | % | LODB Test Method |
| | | | | Described Below |
| 5 | Particle morphology | Pass | — | HR SEM |
| 6 | XRD crystalline test | pass | — | XRD |
| 7 | TGA Oxidation Test | 91.8 | % | Oxidation Test Method |
| | (Si Content Calculation) | | | Described Below |

The composition of the particles by atomic absorption is as follows: Si-89%; C-7.4%; and O-3.6%, with trace amounts of Al, Fe, Mg, and Na.

### PSD Test Method

This test method involves the application of laser diffraction analysis for the determination of the particle size distribution of dry non-surface treated silicon powder. To carry out the test method, about 25 mg of the sample powder is placed in a 100 cc glass beaker. About 60 ml of de-ionized water is added to the beaker. The 100 cc beaker is placed into a 250 cc beaker containing cold water to prevent the sample from over-heating. The probe of an ultrasonic homogenizer (Badelin Sonopuls, Ultrasonic homogenizer rated for 100 W, Model GM 2200) is operated at 90% of the maximum power for a period of three minutes. A few milliliters of the homogenized sample is then added to the measuring cell of the laser diffraction analyzer (Coulter LS 230, equipped with PIDS module and small sample volume module) until the obscurity value is about 10% and PIDS value is between 45% and 65%. The sample is allowed to cool to room temperature and the sonication and measurement steps repeated until it is clear that the sample has achieved a stable particle size distribution. The results are interpreted using the Fraunhofer optical model and the statistical model is based on volume statistics.

### SSA Test Method and LODB Test Method

The test method for the determination of the specific surface area (SSA) of the silicon powder uses nitrogen adsorption/desorption isotherm and is calculated by the BET approach using a Coulter™ SA 3100 Series (Surface Area and Pore Size Analyzer). The powder sample (0.2 g) is dried by vacuum and heating for 30 minutes at 60° C. prior to taking the SSA measurements. Loss on drying (LODB) for the powder is calculated as a difference of the weight before (W₀) and after degassing procedure (W_{outgas}) according to the following formula:

LODB=(W₀−W_{outgas})/W₀*100.

The measuring instrument using the BET calculation approach automatically calculates the specific surface area

### Oxidation Test Method

This test method involves the application of thermal gravimetric (TGA) analysis method for the determination of the Si content in the Si/SiO₂ mixture composition using a-NETZSCH Simultaneous TG-DSC Apparatus STA 409. A sample mass between 10 and 20 mg is heated in air flow (100 ml/min with a rate of 5 grad/min) from room temperature to 1200° C. The total weight percent of Si in the Si+SiO₂ can be measured by the amount oxygen absorbed during the Si oxidation process.

### EXAMPLE 7

This example illustrates a method developed for doping the silicon powder with boron.

Two boron-doped crystalline Si powders (Si-045 and Si-046) were prepared using a method in which boron was introduced into the silica or the magnesium starting material prior to the SHS reaction by the initial precipitation of boric acid H₃BO₃ on the silica or magnesium surface.

### Sample Si-045 (Precipitation of Boron on the Silica Surface).

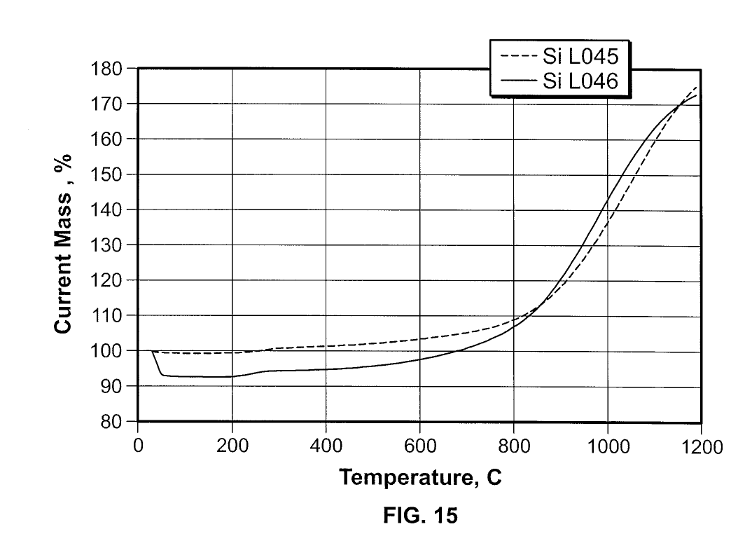

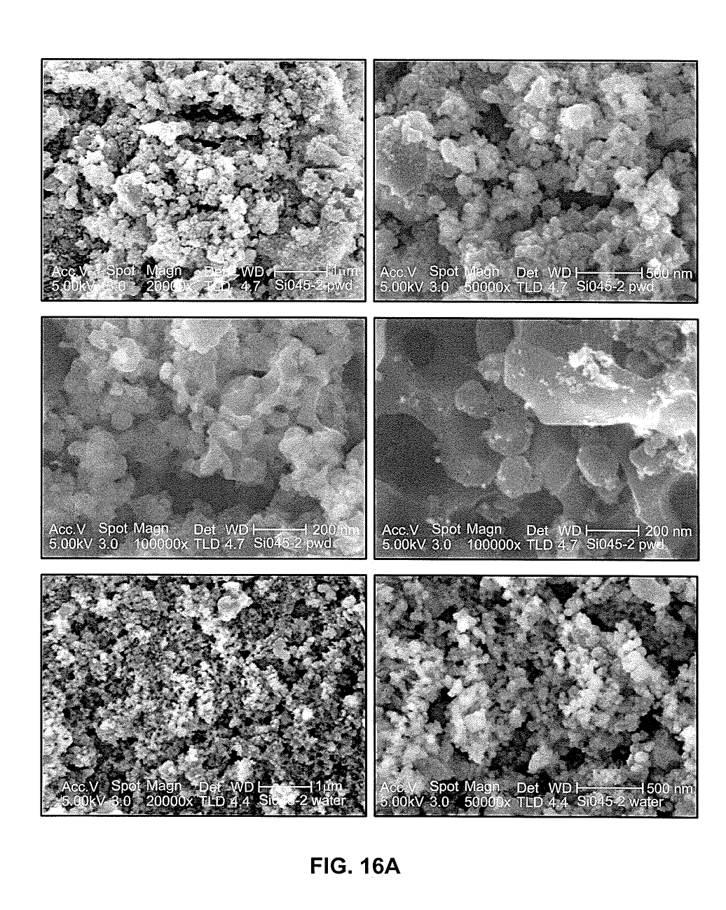

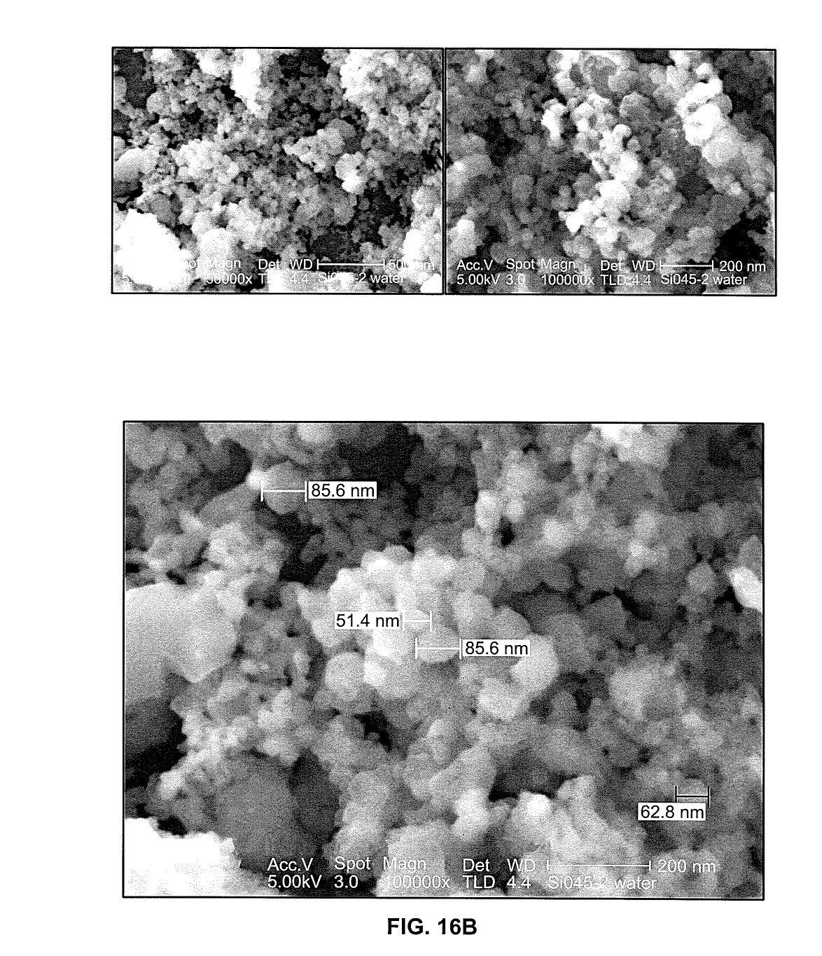

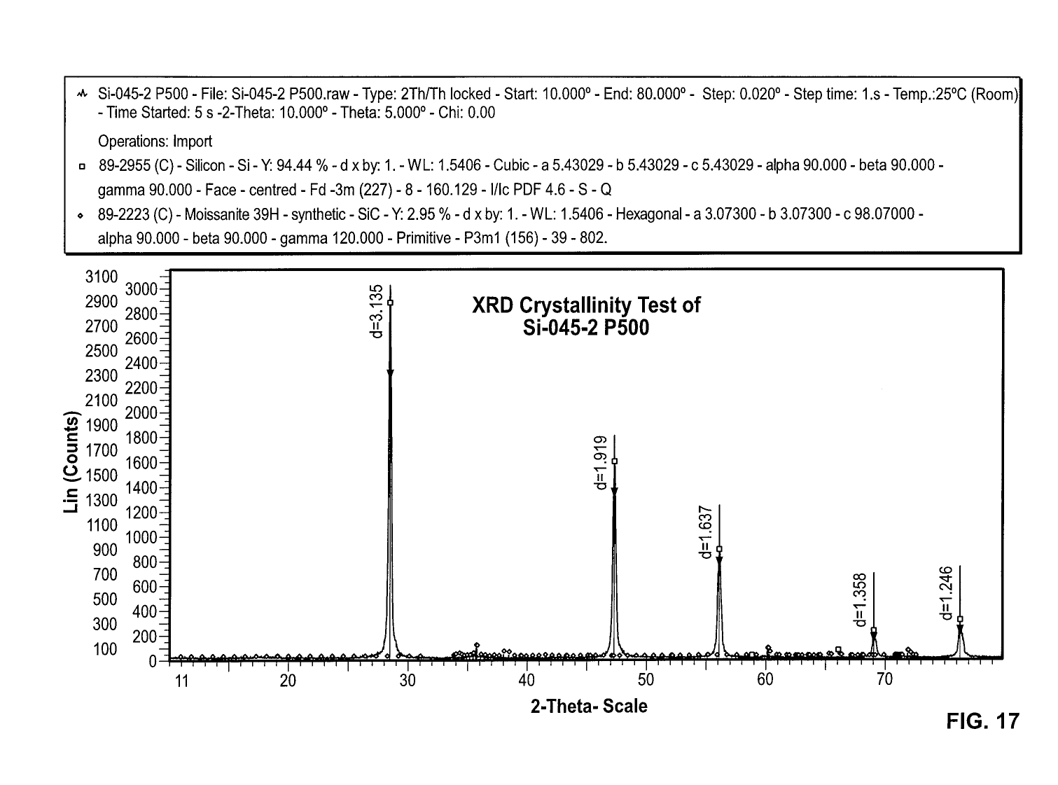

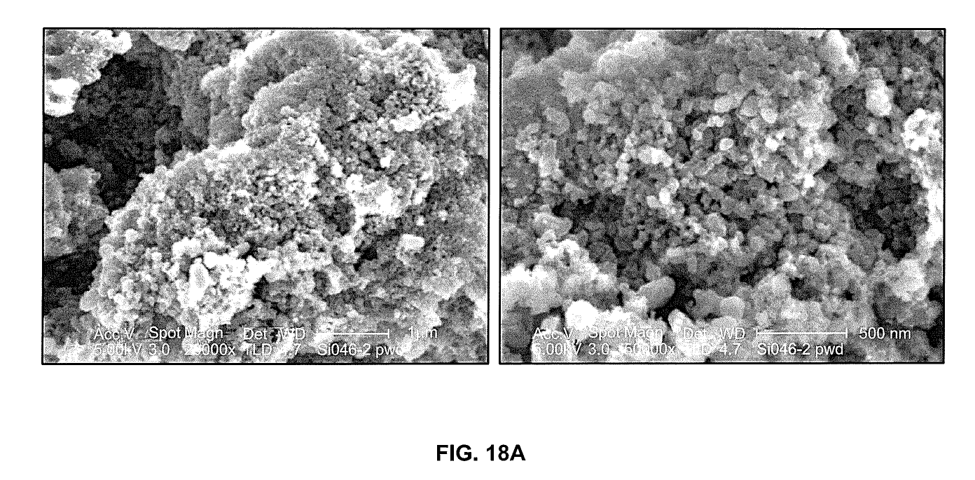

Boric acid H₃BO₃ (0.21 g) was dissolved in 40 ml of ethanol. Silica powder (20 g) was added to the solution, and the ethanol was evaporated in a flume hood at a temperature of about 40° C. After evaporation, the silica powder was mixed for 6 hours in a roll mill with 16 g of magnesium powder and 95 g of magnesium oxide MgO. After that, the formation of the silicon powder was carried out as described in the previous examples, i.e., the reactant mixture was heated in the argon flow in a furnace up to ˜700° C. After cooling the two-stage leaching in HCl and HF acids was done. Crystalline Si powder (6.2 g) was produced (yield about 66%). The results of the oxidation test (FIG. 15) showed that the total silicon content in this powder is 82%. Results of XRD crystallinity testing are shown in FIG. 17. Results of additional testing of the powder are shown in the following table.

| Property | Value | Units |
|---|---|---|
| PSD (Coulter), Water, 15 min sonic: | | μm |
| D90 | 1.88 | |
| D50 | 0.116 | |
| D10 | 0.063 | |
| Average prime particle size | 70 | μm |
| (SEM-See FIGS. 16a and 16b) | | |
| SSA (BET): | 52.7 | m2/g |
| LODB (BET): | 1.06 | % |
| TGA Oxidation test | 86 | % |
| (Si content calculation) | | |

| | Si | C | O | F | Al | Fe | Mg | B |
|---|---|---|---|---|---|---|---|---|
| EDS SEM | 95.03 | 2.86 | N.D. | N.D. | N.D. | N.D. | N.D. | N.D. |
| Atomic | 92.6 | — | — | — | 0.095 | 0.058 | 0.053 | N/A |
| Absorption | | | | | | | | |

Sample L046 (Precipitation of Boron on the Magnesium Surface).

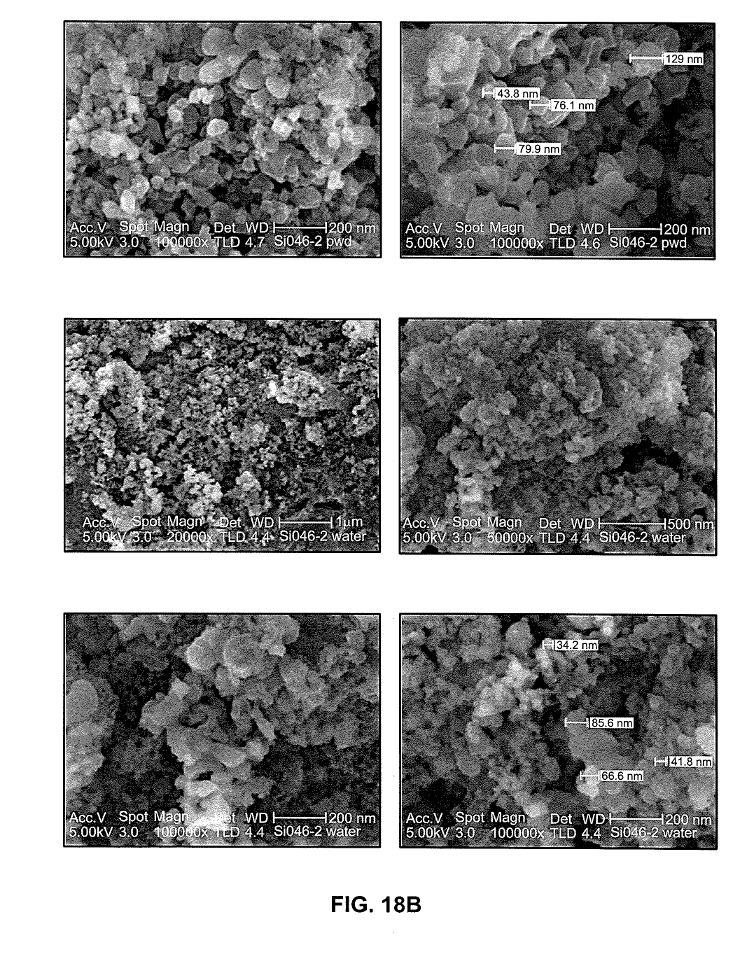

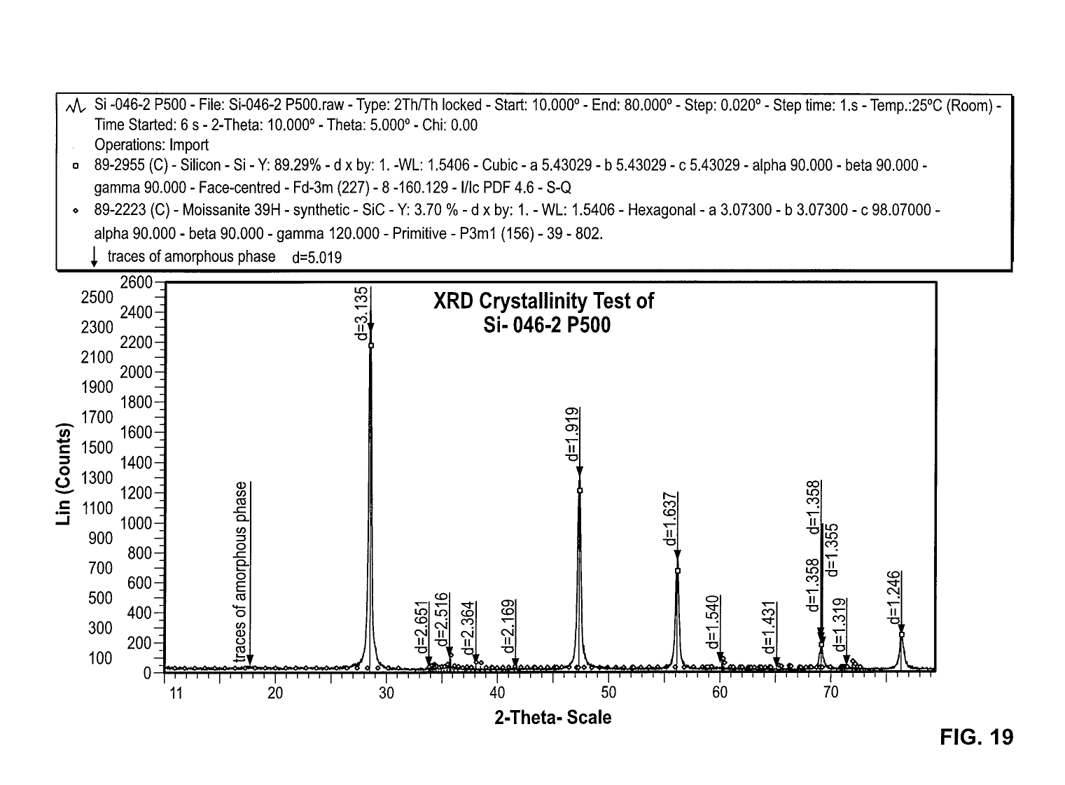

Boric acid H₃BO₃ (0.21 g) was dissolved in 40 ml of ethanol. Magnesium powder (16 g) was added to the solution, and the ethanol was evaporated in a fume hood at a temperature of about 40° C. After evaporation, the magnesium powder was mixed for 6 hours in a roll mill with 20 g of silica SiO₂ and 95 g of magnesium oxide MgO. The synthesis of the silicon powder was then carried out as described in the previous examples by heating the mixture in the argon flow in a furnace up to ˜700° C. After cooling, the two-stage leaching in HCl and HF acids was done. Crystalline Si powder (6.5 g) was produced (yield about 70%). The oxidation test (FIG. 15) shows that the total silicon content in this powder is 87%. Results of XRD crystallinity testing are shown in FIG. 19. The results of other testing of the powder are shown in the following table.

| Property | Value | Units |
|---|---|---|
| PSD (Coulter), Water, 15 min | | μm |
| sonic: | | |
| D90 | 2.36 | |
| D50 | 0.24 | |
| D10 | 0.09 | |
| Average prime particle size | 80 | μm |
| (SEM-See FIGS. 18a and 18b)) | | |
| SSA (BET): | 95.1 | M2/g |
| LODB (BET): | 1.7 | % |
| TGA Oxidation test | 86 | % |
| (Si content calculation) | | |

| | Si | C | O | F | Al | Fe | Mg | B |
|---|---|---|---|---|---|---|---|---|
| EDS SEM | 90.8 | 3.64 | 4.81 | N.D.* | N.D. | N.D. | N.D. | 0.75 |
| Atomic | 90.5 | N/A | N/A | N/A | 0.055 | 0.017 | 0.19 | N/A |
| Absorption | | | | | | | | |

Three additional doped samples were done by the same procedure as mentioned in provisional application (Example 7).

Si L061

Doping by boron through deposition of boric acid on magnesium. Calculated atomic concentration of boron 10¹⁸ atoms/cm³.

Si L062

Doping by boron through deposition of boric acid on magnesium. Calculated atomic concentration of boron 10¹⁷ atoms/cm³.

Si L063

Doping by boron through deposition of boric acid on silica. Calculated atomic concentration of boron ˜5×10²⁰ atoms/cm³.

Results of testing of the powders are shown in the following table.

Si L061

| Property | Value | Units |
|---|---|---|
| PSD (Coulter), Water, 15 min sonic: | | μm |
| D90 | 1.39 | |
| D50 | 0.23 | |
| D10 | 0.096 | |
| Average prime particle size (SEM) | 85 | μm |
| SSA (BET): | 55.4 | m²/g |
| LODB (BET): | 5.0 | % |
| TGA Oxidation test | 86.4 | % |
| (Si content calculation) | | |

| | Si | C | O | F | Al | Fe | Mg |
|---|---|---|---|---|---|---|---|
| EDS SEM | 93.7 | 2.91 | 2.81 | N.D. | N.D. | N.D. | N.D. |
| Atomic | 89.9 | — | — | — | 0.035 | 0.016 | 0.05 |
| Absorption | | | | | | | |

Si L062

| Property | Value | Units |
|---|---|---|
| PSD (Coulter), Water, 15 min sonic: | | μm |
| D90 | | |
| D50 | | |
| D10 | | |
| Average prime particle size (SEM) | 75 | μm |
| SSA (BET): | 60.4 | m²/g |
| LODB (BET): | 2.4 | % |
| TGA Oxidation test | 87.2 | % |
| (Si content calculation) | | |

| | Si | C | O | F | Al | Fe | Mg |
|---|---|---|---|---|---|---|---|
| EDS SEM | 93.5 | 3.64 | 2.51 | N.D. | N.D. | N.D. | N.D. |
| Atomic | 86 | — | — | — | 0.05 | 0.006 | 0.007 |
| Absorption | | | | | | | |

Si L063

| Property | Value | Units |
|---|---|---|
| PSD (Coulter), Water, 15 min sonic | | μm |
| D90 | 2.01 | |
| D50 | 0.26 | |
| D10 | 0.096 | |
| Average prime particle size (SEM) | 75 | μm |
| SSA (BET): | 59.7 | m2/g |
| LODB (BET): | 1.98 | % |
| TGA Oxidation test | 84 | % |
| (Si content calculation) | | |

| | Si | C | O | F | Al | Fe | Mg |
|---|---|---|---|---|---|---|---|
| EDS SEM | 94.3 | 3.13 | 1.66 | N.D. | 0.40 | 0.49 | N.D. |
| Atomic | 84.1 | — | — | — | 0.07 | 0.018 | 0.09 |
| Absorption | | | | | | | |

### EXAMPLE 8

To verify the semiconductor properties of the fine powder crystalline silicon powder when coated on a substrate, a dispersion of the powder was prepared. The powder (prepared in accordance with the method of Example 6) was first treated with HF vapor by placing 0.8 to 0.9 g of the powder on a Teflon film and suspending the film over a 48% HF solution in a closed container overnight. The dispersion was prepared by mixing together 0.70 g of the HF vapor-treated crystalline silicon powder, 4.5 g of isopropanol and 0.35 g of a dispersing agent (Byk 140). The dispersion was coated onto a glass substrate and heated in an oven for one hour at 300°. The coated glass substrate was then heated on a hot plate to 450° C. The coating was tested at the elevated temperature with a two-point probe to measure resistivity. The resistivity of the coating decreased when heated from 10¹⁰ ohms to 2×10⁷ ohms, providing evidence as to the semi-conductor character of the particles.

### EXAMPLE 9

The single particle mobility of the powder produced as in Example 6 was determined by the following method. This method used was based on a method described by Shen it al in “Electrical Characterization of Amorphous Silicon Nanoparticles”, Journal of Applied Physics, Vol. 96, Issue 4, (pp. 2204-2209) 2004.

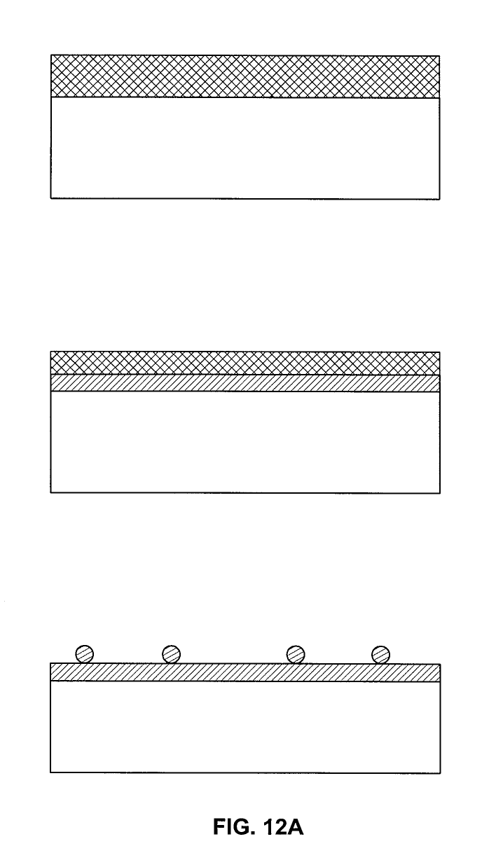

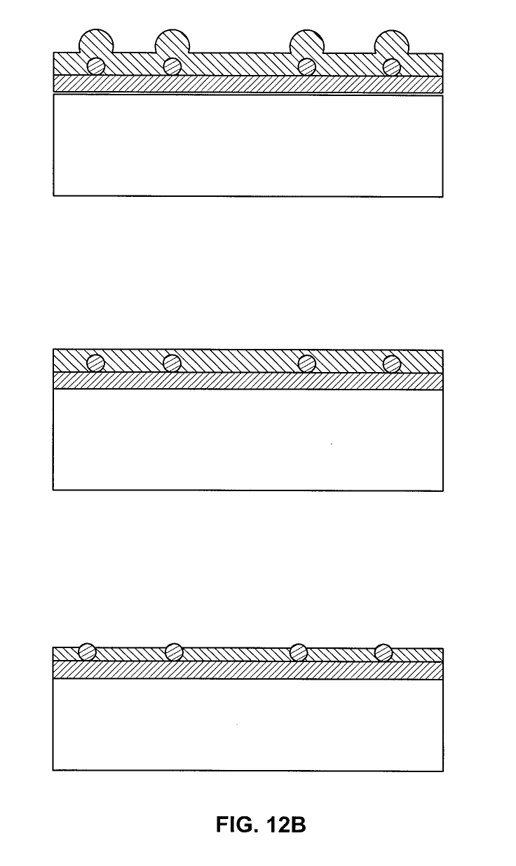

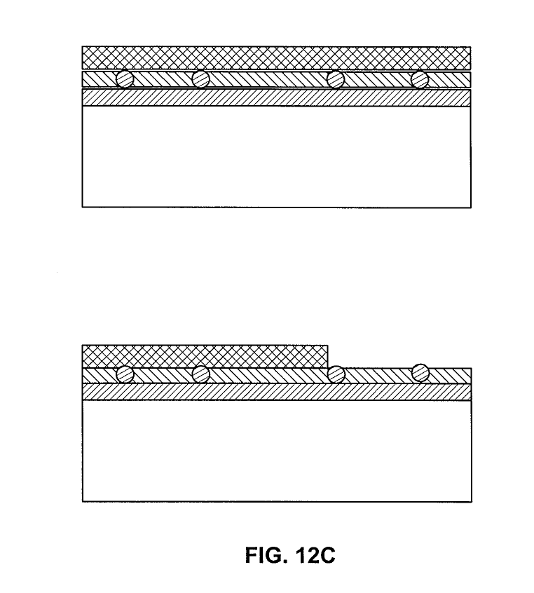

The crystalline silicon powder was suspended without use of a surfactant by placing 0.3 grams of powder in 14.7 grams of carbitol acetate (CAS # 112-15-2) and sonicated for two minutes at 80% power. The resulting dispersion was pushed through a 0.7 micron syringe followed by a 0.45 micron syringe filter. The final dispersion was used create test samples using the following steps as further illustrated in FIGS. 12a, 12b, and 12c:

(1) A substrate 110 was prepared by (a) depositing a 20 nm layer 112 of Pt on a silicon wafer 114; (b) heating the Si and Pt layers at 125° C. for two minutes to create a layer of PtSi 116 at the interface between the Pt layer 112 and the silicon wafer 114; and (c) removing the remaining Pt layer 112 in aqua regia.

(2) The dispersion was spin-coated onto the substrate 110 at a density of about 10 particles per 10 μm².

(3) The particles 118 were embedded in a layer 120 of plasma-deposited SiO₂, annealed at 500° C. for 10 minutes to get good interface with the SiO₂ and form particle contacts, polished to flat, and etched back to expose about 20 nanometers of the particles 118.

(4) A 20 nm layer 122 of Pt was deposited over the particles, annealed at 125° C. for two minutes to form top layer of PtSi 124, and the excess Pt layer 122 layer was removed with aqua regia.

(5) The PtSi layer 124 was patterned and milled to form islands for testing. The samples were then tested.

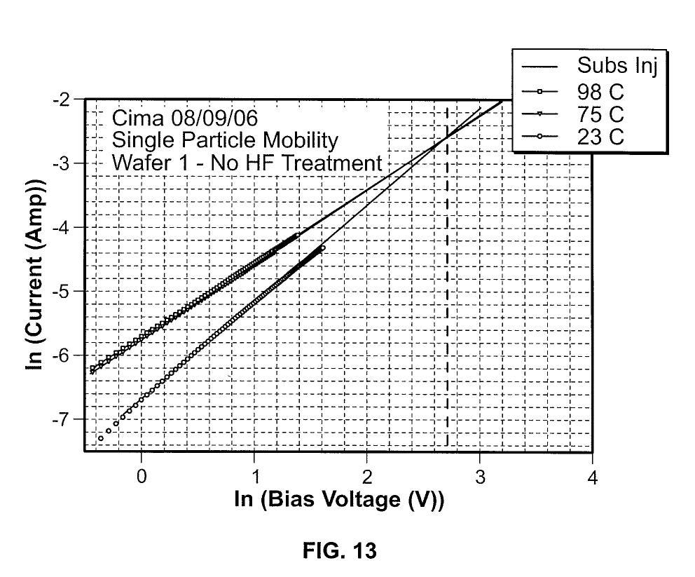

After the sample was prepared, leakage current as a function of temperature and voltage was measured. The results are plotted as shown in FIG. 13 to determine an extrapolated voltage V_{C} at the point where the lines intersect. In this case the V_{C} is about e^{2.7} or 14.8 volts.

Next, a trap density is calculated using the equation

$${N}_{T} = \frac{2 {k}_{Si} {ɛ}_{o} {V}_{C}}{{qd}^{2}}$$

where k_{Si} is the dielectric constant of Si (11.8), ∈₀ is the permittivity of free space (8.84×10⁻¹² F/m), q is the element of charge (1.6×10⁻¹⁹ coul) and d is the diameter of the particle. SEM measurements indicate that these particles are about 60 nm on average. From the data one gets a trap density of 5×10¹⁸ cm⁻³, whereas silicon atomic density is 5×10²² cm⁻³.

Finally to get the mobility expected in this material, the relationship between the trap density and mobility is used. The mobility is related to the free carrier (i.e. ideal silicon mobility) as

$${μ}_{D} = \frac{{μ}_{o}}{1 + {f}_{trap}}$$

where fₜₐₚ is the ratio of time that a carrier is trapped to the time that it is moving in the semiconductor. It can be found as

$${f}_{trap} - \frac{{N}_{T}}{{N}_{TR} ( E ) kT} {e}^{{E}_{T} / kT}$$

where k is Boltzman's constant and T is temperature in degrees Kelvin. Street (Hydrogenated Amorphous Silicon, Cambridge Press 1991) suggests that a reasonable value for N_{TR}(E) is about 3×10²¹ cm⁻³ eV⁻¹. Inserting all of the values

$${f}_{trap} = \frac{5 \times {10}^{18}}{0.026 * 3 \times {10}^{21}} {e}^{39 / 26} = 0.29$$

Thus the room temperature drift mobility in the particle is about equal to the free mobility divided by 1.29. For bulk undoped silicon at room temperature, the free mobility is 1450 cm²/V-sec, so the estimated single particle mobility of these particles is about 1125 cm²/V-sec.

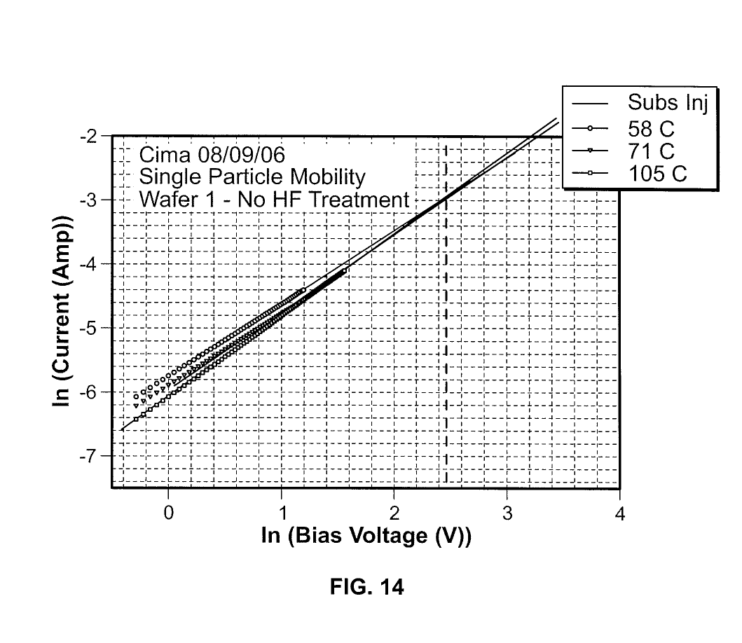

A second sample was run with a very dilute amount of HF in the dispersion. The results are shown in FIG. 14.

The graph is very similar to the results seen without the HF.

A number of embodiments of the invention have been described. Nevertheless, it will be understood that various modifications may be made without departing from the spirit and scope of the invention. Accordingly, other embodiments are within the scope of the following claims.

What is claimed is:

1. A method of producing a fine powder of crystalline silicon comprising:
a. forming a mixture comprising a silicon precursor powder and another ingredient that will generate an exothermic reaction when heated;
b. heating the mixture in a reactor to a temperature at which the exothermic reaction occurs;
c. removing unwanted materials from the reaction mixture; and
d. isolating the fine powder of crystalline silicon.

2. The method of claim 1 wherein said silicon precursor is silicon dioxide.

3. The method of claim 1 wherein said second ingredient is magnesium.

4. The method of claim 1 further comprising adding an inert material to the reaction mixture to control the reaction temperature.

5. The method of claim 4 wherein said inert material is NaCl.

6. The method of claim 4 wherein said inert material is MgO.

7. The method of claim 1 wherein unwanted material is removed from the reaction mixture with a leaching agent.

8. The method of claim 7 wherein said leaching agent is an acid.

9. The method of claim 8 wherein said acid is selected from HCL, HF and acetic acid.

10. The method of claim 1 where a doping agent is included in the reaction mixture.

11. The method of claim 10 wherein the doping agent is included in one or more of the silicon precursor or the another ingredient.

12. The method of claim 1 wherein said crystalline silicon product has an average particle size less than 100 nanometers.

13. The method of claim 1 further comprising forming a dispersion of the powder in a liquid carrier.

14. The method of claim 13 further comprising applying the dispersion to a substrate.

15. The method of claim 13 further comprising treating the powder with HF prior to formation of the dispersion.

16. The method of claim 1 further comprising doping the powder after it has been formed.

17. The method of claim 14 further comprising doping the powder after deposition on the substrate.

18. The method of claim 1 further comprising maintaining the temperature of the exothermic reaction below the melting temperature of the crystalline silicon product.

19. A powder of crystalline silicon powder produced by the process of claim 1.

20. A composition comprising the powder of claim 19 dispersed in a liquid carrier.

21. A powder of crystalline silicon characterized by an average particle size less than 100 nanometers and a single particle mobility of at least 1 cm²/V-sec.

22. The powder of claim 21 characterized by a single particle mobility of at least 5 cm²/V-sec.

23. A composition comprising the powder of claim 1 dispersed in a liquid carrier.

24. A powder of crystalline silicon having an average particle size less than 100 nanometers containing a doping agent.

25. The powder of claim 24 wherein the doping agent is boron.
